(19) United States
(12) Patent Application Publication
(10) Pub. No.: US 2004/0205648 A1
(43) Pub. Date: Oct. 14, 2004

(54) Systems and methods for authoring content

(76) Inventors: David Tinsley, Campbell, CA (US); Frederick Joseph Patton II, San Jose, CA (US)

Correspondence Address: TRAN & ASSOCIATES, 6768 MEADOW VISTA CT., SAN JOSE, CA, 95135, US

(21) Appl. No.: 09/932,344

(22) Filed: Aug. 17, 2001

(51) Int. Cl. G06F 17/21

(52) U.S. Cl. 715/530; 715/500.1

(57) ABSTRACT

A method for authoring content includes acquiring and annotating a content resource; composing one or more scenes and constructing a narrative; and exporting the content.

The present application is related to Application Serial No. ______ , entitled “SYSTEMS AND METHOD FOR PRESENTING CUSTOMIZABLE MULTIMEDIA PRESENTATIONS”, Application Serial No. ______ ,entitled “SYSTEMS AND METHODS FOR DISPLAYING A GRAPHICAL USER INTERFACE”, and Application Serial No. ______ , entitled “INTELLIGENT FABRIC”, all of which are commonly owned and are filed concurrently herewith, the contents of which are hereby incorporated by reference.

### BACKGROUND

This invention relates to authoring systems and processes to create information.

An authoring system is a computer program or a set of computer programs that supports the process of developing information. As discussed in U.S. Pat. No. 6,240,412, one objective of any authoring system or process is to provide search and navigation facilities that help readers find topics of interest. Some authoring systems develop these search facilities after the information is authored. For instance, some authoring systems rely on information retrieval techniques that find information based on the occurrence of a word or phrase in the text. They use computer programs to create the search facility after the author has created the body of information. However, readers find it difficult to retrieve information that fits their needs, since the occurrence of words or phrases can appear in many contexts that are not apropos.

Other authoring systems provide the ability for an author to attach keywords or index entries to a piece of information. Readers search for information through index lookup. This technique suffers from two general problems: (1) the author must have the foresight to identify important keywords or index entries, which is not always possible or practical to do; (2) the same keyword or index entry may end up being used to point to pieces of information in differing contexts, making it difficult for readers to find information relevant to their needs.

In general, the first two authoring system types discussed fail to capture important semantic data about the context in which a piece of information is relevant and useful to a reader.

Other online authoring systems make search facility creation an integral part of the authoring process and also capture important semantic data about the reader's context, but fail to provide a consistent, rigorous method that guides the creation of these search facilities. For instance, hypermedia systems often use graphical mapping techniques and linking mechanisms to communicate the structure of the body of the information in the hypermedia database. However, the author is free to use these mapping techniques and links as desired, so the structure of the information revealed to readers is what the author envisioned, not what is obvious or natural to the readers. Additionally, as information changes over time, it becomes enormously difficult to maintain such a structure of information links due to (1) the idiosyncratic nature of the original structure, and (2) the fact that these links are usually integrated into the body of the information itself, making it difficult to locate links that must change. The result for the reader is a phenomenon called “lost in hyperspace,” in which the reader becomes disoriented by the structure of the hypermedia, or, worse, encounters information links that fail.

As an information corpus becomes large, several authors are needed to create the information collaboratively. Some authoring systems support such collaboration. For instance, they may allow the sharing of computer files, provide a common view of the work-in-progress, or a consolidated outline, in order to facilitate bringing the entire body of work into a coherent whole. Authors still have difficulty, however, in identifying the overall structure of the information corpus, and information that already exists and could be reused. Often some authoring work must be completed before authors can do the analysis and sometimes information must be reworked as a result.

### SUMMARY

A method for authoring content includes acquiring and annotating a content resource; composing one or more scenes and constructing a narrative; and exporting the content.

The acquiring and annotating a content resource can include defining a layout; importing the content resource; applying one or more contextual descriptors and contextual object references; and associating one or more CODECs with the content. The composing one or more scenes and constructing a narrative can include arranging the content in the layout; defining navigational or sequential flow; defining one or more context menus; associating each context menu with its context; specifying one or more design rules for flow customization; compiling, simulating and verifying the behavior of a presentation. The exporting the content can include specifying one of the following: an image destination medium, an access control option, a commerce functionality, and a copy protection option as well as the step of registering an author as a content provider. The exporting the content also includes generating a registered output image.

Advantages of the invention may include one or more of the following. The system helps the author create, as an integral part of the authoring process, search facilities that gather semantic data about reader's context, while at the same time providing a consistent, rigorous method for structuring the information corpus so that authors can constructively collaborate in a nondisruptive manner as an integral part of creating information.

The system uses a pricing model represented in a small, self-contained XML grammar that possesses the granularity and flexibility to model a wide array of pricing models. The use of such a compact grammar throughout the system enables rich comparative structural analysis, and provides a tool for highly scalable analysis of consumer demand and pricing, including powerful simulations of pricing models utilizing usage histories. The user benefits by being able to run precise simulations in regards to planned usage, in addition to having complete, expressive, dynamic pricing information. This removes practices of duplicity and misleading fine print.

Other advantages and features will become apparent from the following description, including the drawings and claims.

### BRIEF DESCRIPTION OF THE DRAWINGS

FIG. 1 shows functional blocks associated with one embodiment of an authoring system.

FIG. 2 shows an exemplary process in authoring content.

FIG. 3 shows a basic pricing architecture.

FIG. 4 shows an alternate pricing architecture.

FIG. 5 shows an environment for processing computerized multi-media presentation transactions.

FIG. 6 shows an exemplary interactive multimedia architecture.

FIG. 7 shows an exemplary authoring system.

FIG. 8 shows an exemplary video filter.

### DESCRIPTION

Referring now to the drawings in greater detail, there is illustrated therein structure diagrams for a multi-media presentation transaction system and logic flow diagrams for the processes a computer system will utilize to complete various interactive multimedia presentations. It will be understood that the program is run on a computer that is capable of communication with consumers via a network, as will be more readily understood from a study of the diagrams.

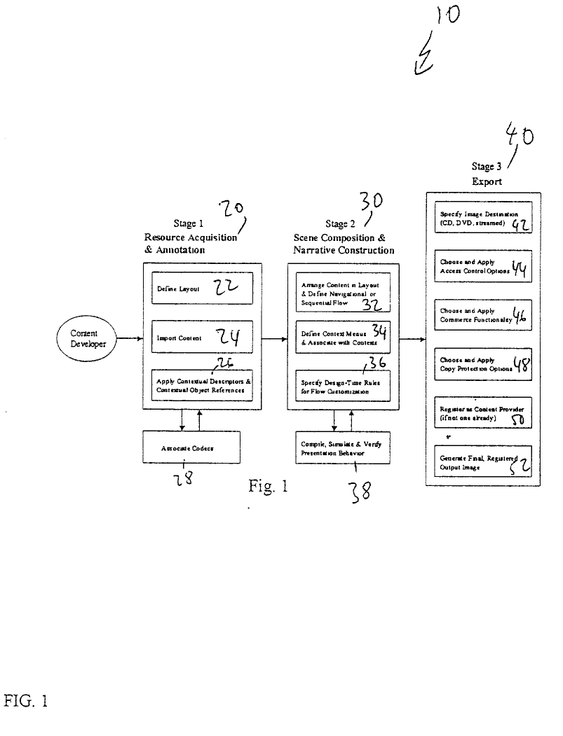

FIG. 1 shows functional blocks associated with one embodiment of an authoring system 10. The system 10 has three major sections: a resource acquisition and annotation section 20, a scene composition and narrative construction section 30, and an export section 40.

Turning now to the resource acquisition and annotation section 20, the section 20 includes a define layout module 22. Here the window layout is chosen. Single or multi-window formats are possible. Given multiple windows, the arrangement of the windows is specified, including options for floating windows and full screen behavior. The section 20 also includes an import content module 24 that performs basic asset management using a prior encoding stage (not shown). The authoring system itself is media-format agnostic.

The section 20 also includes a module 26 that applies contextual descriptors and contextual object references. In the module 26, presentation context descriptors (PCDs) are applied to media stream segments. A PCD uniquely identifies one specific segment of one specific media stream as a discrete context unit. These segments may freely overlap. The primary function of a PCD is to provide contextual feedback to the system, and in so doing, update a user's current presentation context, which is the sum of active contexts for all media streams in all presentation windows. High-level context units might demarcate a scene, while much more granular chunks may specify discrete context units contained within.

Contextual object references (CORs) work in conjunction with PCDs to provide contextual indexing and object-based associations. A contextual object reference may be attributed to any number of PCDs as well as to other CORs. CORs then establish granular relationships within and amongst media streams. Given visible CORs, the user could seek directly to scenes involving a particular actor instead of manually scanning through the content. A contextual object reference could refer to concrete entities (people, places and things) as well as to abstract signifiers (subject matter, style and mood).

The following discussion applies to two actors uniquely identified by respective CORs. Given the ability to attribute a contextual object reference to other CORs, an additional COR could be applied to the above-mentioned CORs to create an association. For instance, this aggregating COR could represent the set of villains, of which the two actors could be members. In addition to seeking to the next instance of a particular COR, the user could specify a group of CORs and a search method, such as “all” or “any.” In this case, the collection of CORs would serve as a contextual filter.

Unlike context menu entries (CMEs) which signify access to contextually related content, PCDs and CORs merely delineate context for feedback and searching. A PCD is used to distinguish a specific occurence, whereas CORs flag recurring context elements.

The section 20 also includes a Codec association module 28. As the authoring system is media-format agnostic, codecs are used to interface with arbitrary media formats.

Turning now to the scene composition and narrative construction section 30, the section 30 includes a module 32 that arranges content in layout & defines navigational or sequential flow. Each presentation window utilizes a time line so that media streams may be applied to a particular window, coordinate position, and sequential order. The sequential ordering may be bypassed by non-linear navigation, such as navigation menus. A system-generated BiFS stream incorporates and articulates these choices.

The section 30 also includes a module 32 that allows the user to define context menus & associate with contexts. Interactive context is triggered by the user, unlike traditional menus. Interactive context provides a means for the user to access contextually related information via a context menu at any time. Given the triggering of a context menu, all currently validated context menu entries (CMEs) are accumulated into a hierarchical context menu. A CME is applied to a PCD or a COR.

A context menu entry will indicate what text and text properties to present to a user, as well as the hierarchical location within the menu. For instance, a scene with Robert DeNiro and Al Pacino meeting in a cafe, could specify the contextual nodes related to DeNiro shown in the following pseudo code.

<Actors><Robert DeNiro><list of credits>

<Actors><Robert DeNiro><interviews><with DeNiro about this movie>

<Actors><Robert DeNiro><interviews><on DeNiro in this movie>

<Actors><Robert DeNiro><interviews><other interviews with DeNiro>

<Actors><Robert DeNiro><interviews><other interviews on DeNiro>

<Actors><Robert DeNiro><tidbits>

The bracketing depicts the positioning within the menu. Then end-actions, similar to the HREFs of HTML, have been omitted, but conform to the following format: <localStreamID=remoteStreamID=″″ transitionStreamID=″″>, which specifies where the content can be found, and depending on the connection type. In order to specify a PCD offset into a stream, a decimal point followed by the PCD id is used. For instance, content with no local streamID, would be grayed out or omitted, depending on the GUI preference, if no Internet connection was active. A transitional stream is a local placeholder used to increase perceived responsiveness and provide feedback in regards to stream acquisition.

The section 30 also includes a module 36 that allows the user to specify design-time rules for flow customization. Based on the use of CORs, the author can take advantage of parameterization. By collecting input from the user or by querying the system in regards to usage analysis, the author can articulate rules for dynamic content flow customization. An example illustrating the use of user feedback is a customizable music video. The following content streams might be available: principle audio track, remix audio tracks, concert audio takes, alternate thematic audio interjections (dialog from the movie or something), studio takes video track, concert video takes, video takes, alternate close-ups and perspectives, multiple alternate thematic video content, and karaoke overlay options. These different streams would be heavily described by CORs. Given feedback by the user, the author could designate rules based scripting attributed to CORs in order to design the flow. Here, we would have a customized video. This could, in the event of remixes and alternate takes, correspond to different lengths of presentation, such as to accommodate heavy guitar solos or supplemental thematic content. This would rely heavily on parallel alternate time lines. All streams need not offer contiguous content. A select track, might instead, offer occasional embellishments, such as mixing in audio or replacing audio and/or video for certain segments. This content could all be stored, unassembled with the original content distribution. These rules could be conveyed in the BiFS streams. When user input is not utilized, the designer could query the system in regards to COR-related statistics, and branch accordingly. This would require an online session.

The section 30 also includes a module 38 that allows the user to compile, simulate, & verify presentation behavior. During compilation, a BiFS stream is generated, which will convey composition and navigation. Object Content Information (OCI) streams and MPEG-7 streams may also be generated to convey contextual information. Other supplemental streams, such as MPEG-4 Object Descriptor streams may also be generated. Associated codecs will be utilized for rendering.

Turning now to the export section 40, a module 42 allows the user to specify image destination (for example, CD, DVD, or streamed). This corresponds to the storage location, as opposed to any particular format. A module 44 allows the user to choose and apply copy protection options. Copy protection mechanisms consists of any Digital Rights Management (DRM) mechanisms available on the network. The DRM mechanism employed remains registered within the ASP network, and is not identified with the content. Instead, the presence of copy protection is indicated through access control information, discussed below. At that point, the system must be communicated with, and given validated user access, the DRM access keys may be sent periodically, to decrypt the content. Access validation is identified by account information, and may include constraints such as password protection or regional protections.

Additionally, a module 46 allows the user to choose and apply access control options. The access control options indicates what restrictions are operative. These constraints include pricing, password protection (such as for parental control and organizational role based access), and regional. An Intellectual Property Management and Protection (IPNP) framework corresponding to the ISO/IEC 14496 MPEG-4 systems specification is used for the conveyance of access information. This specifies the use of elementary streams and IPMP descriptors to make protected ISO/IEC 1496 content available to the playback system. An IPMP elementary stream may be associated with a given elementary stream or set of elementary streams. IPMP descriptors may be used to convey time-invariant or slowly changing IPMP information associated with a given elementary stream or set of elementary streams. Scene descriptions (BiFS) are treated like any other elementary stream, and may be protected by IPMP stream(s). This is not a necessity of the invention, but is chosen for compatibility with generic MPEG-4 playback systems. The particular playback system must understand the IPMP protective mechanism employed by the streams or fail access to the streams, as per the MPEG-4 specification. Upon understanding the mechanism, the playback system may utilize the IPMP systems mechanism. The access control information simply indicates the presence of non-commercial constraints, commercial constraints, and copy protection. These indications are specified via IPMP descriptors. Given any of these constraints, the playback system will contact the system for user authentication and authorization. System feedback may involve the periodic exchange of keys, depending on the protection mechanism.

The section 40 also includes a module 48 that allows the user to choose and apply commerce functionality. The same general purpose pricing model is utilized both for software components and for content. In this instant, the pricing model can be considered in terms of content generated by the authoring system. The pricing model represents a small, self-contained XML grammar that possesses the granularity and flexibility to model a wide array of pricing models. The use of such a compact grammar throughout the system enables rich comparative structural analysis, and provides a tool for highly scalable analysis of consumer demand and pricing, including powerful simulations of pricing models utilizing usage histories. The user benefits by being able to run precise simulations in regards to planned usage, in addition to having complete, expressive, dynamic pricing information. This removes practices of duplicity and misleading fine print.

For inter-model scalability, pricing models are situated in a pricing expression tree structure, which is located within the ASP network. Each pricing model represents a pricing node. A pricing node may articulate a override condition, that if true, can alter the pricing of the structures beneath it. This override expression, may constrain the sub nodes by expression of ALL or ANY. The pricing expression may be replaced or altered utilizing a Billing Modification Attributes object, to be discussed below.

Each content segment or stream may reference a pricing node, via a pricing node id. In these cases, a pricing node may be referenced from multiple sources. A pricing node need not be referenced by any streams or content segments to affect their pricing. In such a case, by containing referenced pricing nodes beneath it, given a true evaluation of its override condition, the containing pricing node may alter or replace the pricing expressions of contained nodes. When multiple sources share a pricing node, they are treated as a single entity. Now, a containing pricing node need never be referenced. As long as a sub node is referenced, its override condition is evaluated. The condition expressed by a pricing node may reference within its conditional expression other external pricing nodes not contained beneath its pricing node. In this case, if the external referenced node has an override condition, that expression is evaluated. A source may only directly reference a terminal pricing node, which by rule, has no sub nodes and no override expression, evaluating to true when the pricing node is associated to the user via an access license. By referencing independent, pricing nodes not contained beneath it, a pricing node may accomplish competitive pricing, such as by providing discounts for those who have purchased competing products.

As a stream may have multiple choices in regards to pricing models, an intermediate pricing node is referenced. The intermediate pricing node may not exist within the pricing expression tree. Therefore, given a correlation between user and pricing nodes within the access license, the intermediate pricing node resolves to a terminal pricing node within the pricing expression tree.

The core components of the pricing model are

Billing Attributes

Billing Cycle

Conditional Trigger Entry (or simply Trigger Entry)

Billing Modification Attributes

Billing Attributes is the foundation of the pricing model and consists of a collection of billing attributes out of which pricing expressions are built. These billing attributes have parameters to further tune their expressions. A by-product of this is that an equivalent expression can sometimes be arrived at using different attributes. There are five non-mutually exclusive billing attributes:

fixed rate use cost: every use of the resource incurs a fixed charge

metered use cost: a billing rate is applied to the time period with which a user utilizes the given resource

billing cycle cost: rights to the resource exacts a charge per billing cycle

installment cost: the specified rights to the resource can be purchased in installments; neither the extent of use nor time period of usability is necessarily unlimited in this case; the license will articulate any provisions in these regards

simple flat rate cost: the specified rights to the resource can be purchased in a lump sum; neither the extent of use nor time period of usability is necessarily unlimited in this case; the license will articulate any provisions in these regards Each of the five billing attributes contains a field specifying:

currency: the currency type

value: the monetary value

pre-paid percentage: generally 0 or 100, and specifies whether the charges, or a portion of the charges, must be paid upfront

For the metered use billing attribute, this necessitates a pre-paid lump sum such as is found with certain cellular phone plans. In addition, metered use cost contains a field indicating the unit of time incorporated in the rate; and installment cost indicates the total number of installments to be paid.

Billing Attributes alone can provide a wide variety of pricing expressions. In fact, Basic Pricing consists solely of the Billing Attributes component. The billing process, in addition to arriving at what to charge, must also determine when to charge it. The Billing Cycle component fulfills this function. While billing cycle could have been left out of the pricing model proper, it is included so that the user may understand the various billing ramifications.

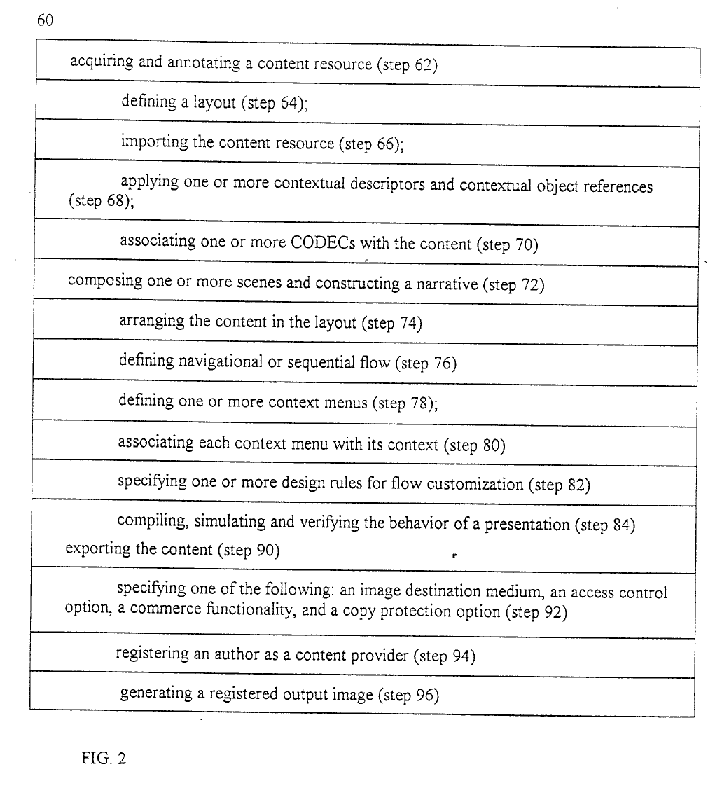

FIG. 2 shows an exemplary process 60 in authoring content. The process 60 includes acquiring and annotating a content resource (step 62) which includes defining a layout (step 64); importing the content resource (step 66); applying one or more contextual descriptors and contextual object references (step 68); and associating one or more CODECs with the content (step 70). The process 60 also includes composing one or more scenes and constructing a narrative (step 72), which in turn includes arranging the content in the layout (step 74); defining navigational or sequential flow (step 76); defining one or more context menus (step 78); associating each context menu with its context (step 80); specifying one or more design rules for flow customization (step 82); compiling, simulating and verifying the behavior of a presentation (step 84). The process 60 also includes exporting the content (step 90). Step 90 can include specifying one of the following: an image destination medium, an access control option, a commerce functionality, and a copy protection option (step 92) as well as the step of registering an author as a content provider (step 94). The exporting the content also includes generating a registered output image (step 96).

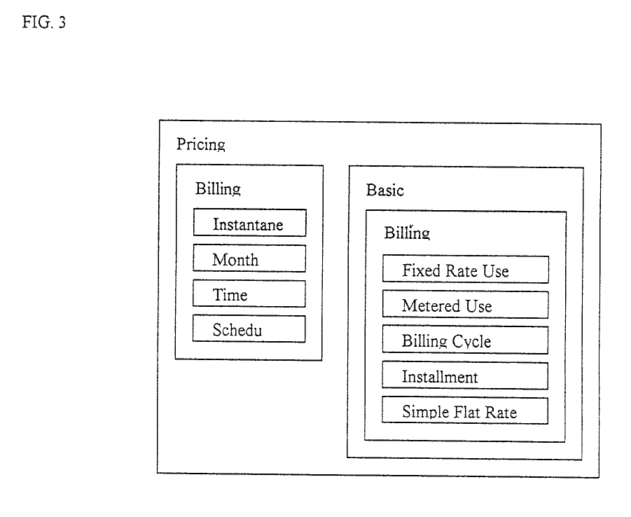

FIG. 3 shows a Basic Pricing architecture in which a billing cycle communicates the billing schedule and facilitates its automation. Related commerce issues such as failed payment transactions, late payments, partial payments, or non-payments, are handled within the licensing model.

Four mutually exclusive methods for specifying a billing cycle are provided:

instantaneous: payment is due immediately

monthly: either the dayOfMonth field is specified, or the dayOfWeek and ordinal fields are specified, i.e. dayOfWeek=“Tuesday” ordinal=“third” versus dayOfmonth=“21”

time period: one or more of the following fields may be employed-hours, days, months, years

schedule: one or more due date specifications can be employed, which consist of fields for year, month, and day

The use of Basic Pricing, which consists solely of Billing Attributes, and Billing Cycle is enough to specify a complete pricing model. However, it does not enable scalable or variable pricing.

When Basic Pricing does not provide enough flexibility, the more powerful alternate pricing model can be employed, whether in conjunction or as a replacement to Basic Pricing. At its core, Alternate Pricing functions identically to Basic Pricing, and contains the same Billing Attributes component. The difference is that Alternate Pricing can utilize conditional triggers, whether instance-based, expenditure-based, or meter-based. With Alternate Pricing, conditional triggers are evaluated before applying the Billing Attributes. These triggers can modify the Billing Attributes to enable price scaling and conditional pricing. If Basic Pricing and Alternate Pricing are both present, the triggers for Alternate Pricing are first evaluated. Once an Alternate Pricing condition has been triggered, Alternate Pricing replaces Basic Pricing. Alternate Pricing may contain zero or one Trigger Definition components. The presence of Alternate Pricing requires a Billing Attributes component, but not a Trigger Definitions component.

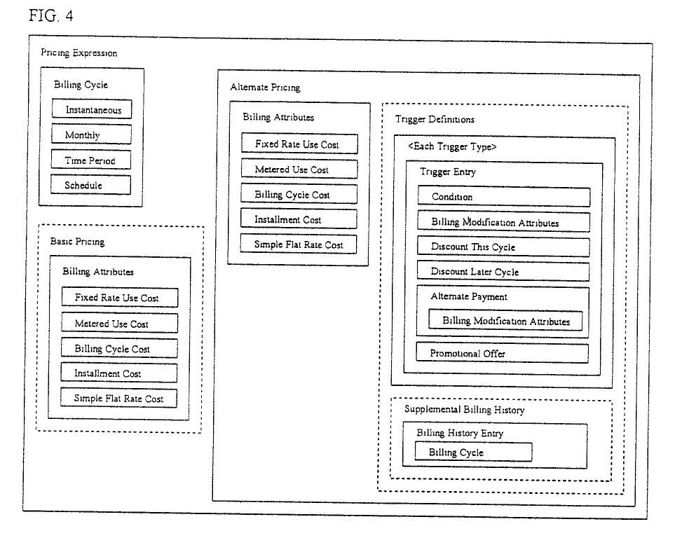

FIG. 4 shows an alternate pricing architecture. In this embodiment, trigger definitions consists of four sub components:

Instance Trigger

Expenditure Trigger

Metered Trigger

Supplemental Billing History

Each trigger contains a Billing History Scope field, to be discussed below. In addition, each trigger contains a collection of zero or more Trigger Entry nodes. Semantically, the difference lies in how the Trigger Entry nodes are interpreted.

The trigger definitions node may also contain a Supplemental Billing History node, which itself, may contain one or more Billing History Entry nodes, which consist solely of a Billing Cycle. This node provides the ability to consider alternate billing periods for purposes of evaluating trigger conditions. For instance, though the billing cycle may be monthly, the pricing model may want to consider the larger account history outside of the current billing cycle in regards to discounting or price scaling. The flexibility exists to also examine subsets within the current billing history or a previous non-overlapping period, such as the previous billing cycle.

Each trigger type (instance, expenditure, metered) includes a scope attribute. The attribute is optional, and defaults to zero, which corresponds to the current billing cycle. A non-zero value must correspond to the scope ID of a billing history entry, thus linking it to an alternate billing cycle. Multiple trigger types of the same scope are not permitted within a trigger definitions node. Trigger entries provide a step or milestone at which pricing scaling, discounting, revised buyout options, or promotional offers can take place. Billing modification attributes that appear within triggers only replace those of like form, leaving intact any other attributes. To remove a billing attribute, its value should be set to zero. Discounts specified within a trigger are only valid upon activation of the trigger, that is, once per trigger, and are accumulated with any other discount declarations.

Trigger Entry contains the following components:

Condition

Billing Modification Attributes

Discount This Cycle

Discount Later Cycle

Alternate Payment

Promotional Offer

In each case, the node may be present zero or one times. The first node is the key to how the trigger entry is interpreted; it represents the condition on which the trigger is to be evaluated. It accepts a generic value that is interpreted basic on what type of trigger contains the entry. The lack of a Condition node means the condition is automatically validated as true.

While the Condition node represents the criterion for evaluation, the rest of trigger entry's nodes are transformation parameters, which specify the result. The first of these nodes is the Billing Modification Attributes node. Billing Modification Attributes add a twist to Billing Attributes, in that in addition to specifying a new value, a percentage or value adjustment can be applied to a pre-existing value. Each billing modification attribute, such as fixed rate use cost, can contain any one of the following fields in place of value: reduce by value, reduce by percentage, increase by value or increase by percentage. These alternative attributes enable differential modification of pre-existing values. It is invalid to use them to modify an attribute that has not been defined.

Through triggers, Alternate Pricing enables discount declaration. Discounts are similar to Alternate Pricing, but whereas Alternate Pricing is forward looking, meaning future usages are billed at new rates, discount declarations look back, retroactively accumulating a discount specified by each trigger. In this event, whereas Alternate Pricing is modified, discounts are always accumulated into a running refund total. Discounts may be applied to the current billing cycle and the next billing cycle. Discounts allow vendors another method of enticing users to reach usage milestones.

Alternate payment is a special hook enabling buyout options, such as with installment plans. Alternate payment contains a billing modification attributes node, which is used to revise the billing attributes of alternate price, such as reducing the payments to zero.

The promotion offer hook enables special offers to be keyed to conditional milestones.

The indication of commercial constraints within access control information corresponds to the transmission of pricing node identifiers associated with the content stream or segment. This is time-varying information conveyed in the IPMP stream. Restricted content, such as for commercial constraints, by provide the user with information to acquire the resource, if appropriate.

The system will provide pricing feedback to the playback system in a dedicated back channel. For actual billing, this will depend on the billing cycle. Actual transactions will be carried out by payment systems, which will generally be carried out over HTTP or HTTPS. Billing state and history will remain logged on the system. The content provider will be able to define contingencies for issues such as failed transactions and delinquent accounts. These mechanisms may include feedback messages to the user, which may include interactive forms.

Register as Content Provider If Not One Already

The user must register as a content provider.

Generated Final, Registered Output Image

Contingent database tables are populated within the ASP network, as well as generated the output image.

In one embodiment, the authoring system supports the following features:

1. ASP Style Design

2. Modular Integration

3. Support for Multiple Audio and Video Codecs

4. MPEG 7

5. BiFS Layer Navigation Stream Creation

6. MPEG 4 Multiplex

7. Prop 21 Server Configuration Export

8. Integrated Encoder Control

9. Integrated Simulator

10. Symmetrical Multiprocessing Scalability Manager

11. Distributed Processing Scalability Manager

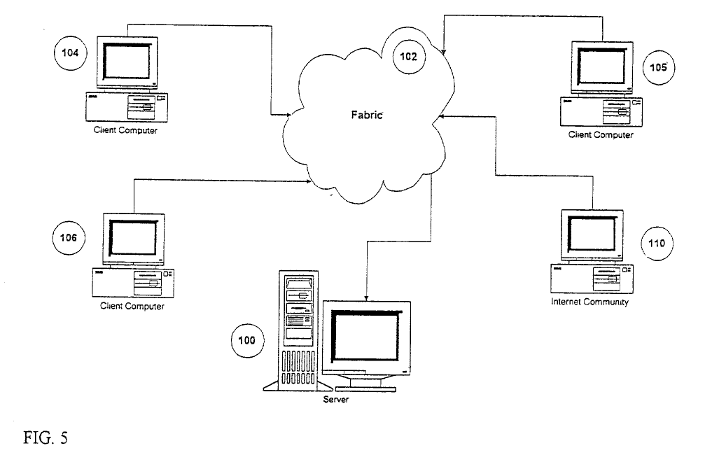

FIG. 5 shows an environment for handling presentations generated using the authoring system discussed above. A server 100 is connected to a network 102 such as the Internet. One or more client workstations 104-106 are also connected to the network 102. The client workstations 104-106 can be personal computers or workstations running browsers such as Netscape or Internet Explorer. With the browser, a client or user can access the server 100's Web site by clicking in the browser's Address box, and typing the address (for example, www.isc.com), then press Enter. When the page has finished loading, the status bar at the bottom of the window is updated. The browser also provides various buttons that allow the client or user to traverse the Internet or to perform other browsing functions.

An Internet community 110 with one or more media companies, service providers, manufacturers, or marketers is connected to the network 102 and can communicate directly with users of the client workstations 104-106 or indirectly through the server 100. The Internet community 110 provides the client workstations 104-106 with access to a network of media specialists such as music/video distributors. Additionally, the Internet community 110 also provides access to a variety of supporting members.

Although the server 100 can be an individual server, the server 100 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 100 can also be protected by a firewall. When the firewall receives a network packet from the network 102, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 100. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 100 supports a multi-media presentation transaction portal that provides a single point of integration, access, and navigation through the multiple enterprise systems and information sources facing knowledge users operating the client workstations 104-106. The portal can additionally support services that are transaction driven. Once such service is advertising: each time the user accesses the portal, the client workstation 104 or 106 downloads multi-media information from the server 100. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal.

Additionally, the portal offers contents and forums providing focused articles, valuable insights, questions and answers, and value-added information about related issues, including music and video information. For example, the information can relate to various singer's web sites, among others.

Other services can be supported as well. For example, a user can rent space on the server to enable him/her to download application software (applets) and/or data—anytime and anywhere. By off-loading the storage on the server, the user minimizes the memory required on the client workstation 104-106, thus enabling complex operations to run on minimal computers such as handheld computers and yet still ensures that he/she can access the application and related information anywhere anytime. Another service is On-line Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee.

The server 100 allows a consumer to log onto a computerized multi-media presentation transaction system over a network and automates the steps required to complete a multi-media presentation transaction.

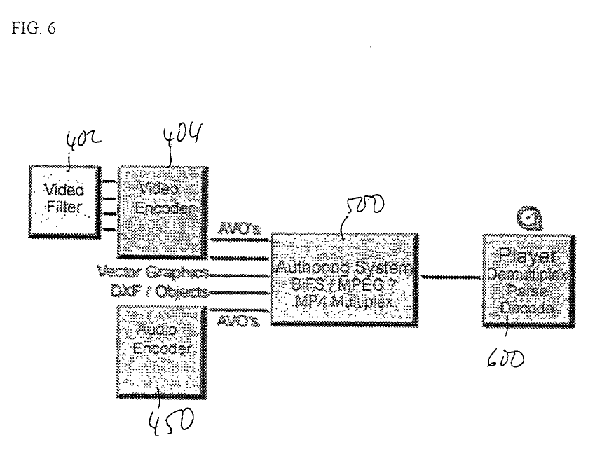

FIG. 6 shows an exemplary interactive multimedia architecture with Encoding/Authoring/Player components. The system includes a video filter 402 connected to a video encoder 404. The output of the video encoder 404 is provided to an authoring system 500. The authoring system 500 also receives data from an audio encoder 450. The output of the authoring system 500 is transmitted to a user through a number of mechanisms: transmitted over the Internet, transmitted over the airwaves, printed on CDs or DVDs, or a combination of the above mechanisms, for example. The output of the authoring system 500 is eventually played by a player 600.

In one embodiment, the player 600 is based on QuickTime Plug-in architecture. The player design includes the following capabilities: De-Multiplex, BiFS Parser, DIP Parser. The player 600 can also invoke multiple codecs simultaneously.

The encoder 404 delivers capability to the end user, which is scalable to their budget. While solutions in the MPEG 4 to arena can represent the most attractive potential for the future, it is important to keep in perspective the advancements and advantages of other video formats with regards to the immediate markets that they address. Each encoder implementation is a component implementing CIA and the encoder plug-in interface represented in the reference software, and in satisfying this requirement, is vendor agnostic. Here are some encoder examples: MPEG 1, MPEG 2, MPEG 4, QuickTime, Sorensen, AVI, MJPEG, DV, VP3, and DivX. Audio codecs that can be supported include PCM, MPEG 2, AAC, CELP, MP3, and Structured Audio.

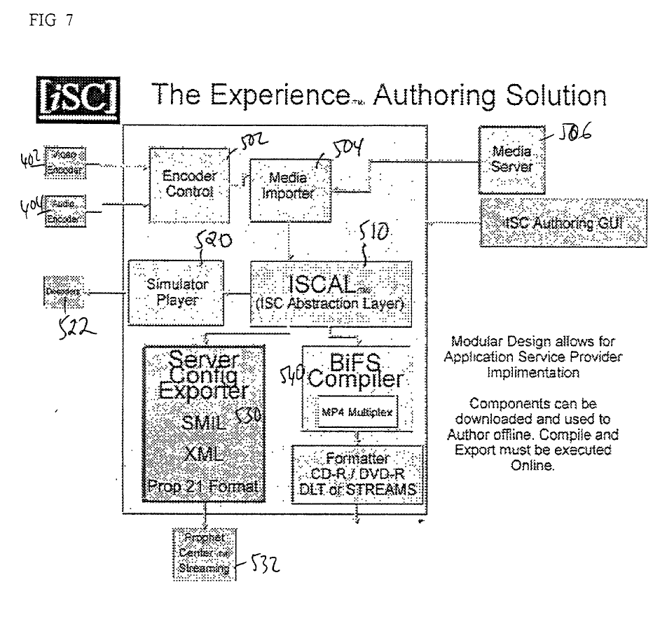

One implementation of the authoring system 500 is shown in more detail in FIG. 7. This embodiment of the authoring system 500 receives encoded data from the video encoder 402 and the audio encoder 404 and provides the incoming data to an encoder control 502. The output of the encoder control 502 is provided to a media importer 504. The media importer 504 also receives input from a media server 506. The output of the media importer 504 is provided to a layer abstraction engine 510. The layer abstraction engine 510 provides outputs to a plurality of devices. For example, the layer abstraction engine 510 drives a simulator player 520 whose output is provided to one or more decoders 522. The layer abstraction engine 510 drives an exporter 530, which handles XML data. The exporter 530 is connected to a streaming engine 532. The layer abstraction engine 510 also drives a BiFS compiler 540, which formats data for one or more output streams for CD, DVD or other suitable data streams.

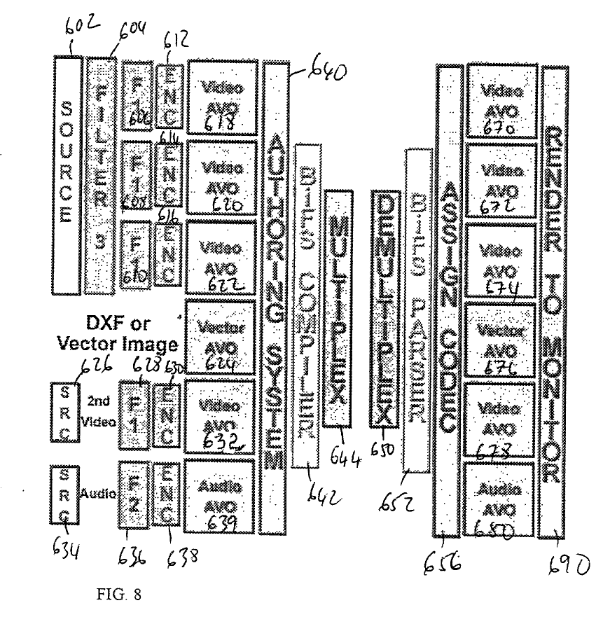

FIG. 8 shows an exemplary video filter capable of “learning” attributes to various objects in a video stream. The filter receives data from one or more sources 602. The source data is provided to a filter 604 and is broken into components F1 606, 608 and 610, each of which is fed to respective encoders 612, 614 and 616. The outputs of the encoders 612-616 are provided to audio/video objects (AVOs) 618, 620 and 622, respectively. The outputs of the AVOs are provided to an authoring system 640.

The authoring system 640 also accepts vector images using a vector AVO 624. Additional video sources such as a second video source 626 is received through a second filter 628, an encoder 630 and a second video AVO 632, respectively. The authoring system 640 can also accept additional audio sources such as an audio source 634, whose output is provided to an audio filter 636, an encoder 638, and an audio AVO 639, respectively.

The authoring system 640 sends its output to a BiFS compiler 642 and a multiplexer 644. The resulting file is transmitted to a viewer. The viewer has a demultiplexer 650 that sends output to a BiFS parser 652. Based on the parser operation, the received stream is assigned using an assign CODEC 656 to video AVOs 670-674, vector AVO 676, second video AVO 678 and audio AVO 680. Based on the output of the AVOs 670-680, a rendering engine 690 outputs the multimedia stream onto a computer screen.

The above system allows a party to complete a multi-media presentation transaction from beginning to end using the authoring system. This makes the multi-media presentation transaction process highly customizable for the consumer.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

[image]

[image]

[image]

[image]

[image]

[image]

[image]

[image]

[image]

[image]

[image]

[image]

[image]

[image]

[image]

What is claimed is:

1. A method for authoring content, comprising:
acquiring and annotation a content resource;
composing one or more scenes and constructing a narrative; and
exporting the content.

2. The method of claim 1, wherein the acquiring and annotating to resource further comprises defining a layout.

3. The method of claim 1, wherein the acquiring and annotating the resource further comprising importing the content resource.

4. The method of claim 1, wherein the acquiring and annotating the resource further comprising applying one or more contextual descripors and context object references.

5. The method of claim 1, wherein the acquiring and annotating the resource further comprising associating one or more CODECs with the content.

6. The method of claim 1, wherein the composing one or more scenes and constructing a narrative further comprises arranging the content in the layout.

7. The method of claim 1, wherein the composing one or more scenes and constructing a narrative further comprises defining navigational or sequential flow.

8. The method of claim 1, wherein the composing one or more scenes and constructing a narrative further comprises defining one or more context menus and associating each context menu with its context.

9. The method of claim 1, wherein the composing one or more scenes and constructing a narrative further comprises specifying one or more design rules for flow customization.

10. The method of claim 1, wherein the composing one or more scenes and constructing a narrative further comprises compiling, simulating and verifying the behavior of a presentation.

11. The method of claim 1, wherein the exporting the content further comprises specifying one of the following: an image destination medium, an access control option, a commerce functionality, and a copy protection option.

12. The method of claim 1, wherein the exporting the content further comprises registering an author as a content provider.

13. The method of claim 1, wherein the exporting the content further comprises generating a registered output image.

14. A method for authoring content, comprising:
acquiring and annotating a content resource, including
defining a layout;
importing the content resource;
applying one or more contextual descriptors and contextual object references; and
associating one or more CODECs with the content.
composing one or more scenes and constructing a narrative, including:
arranging the content in the layout;
defining navigational or sequential flow;
defining one or more context menus;
associating each context menu with its context;
specifying one or more design rules for flow customization;
compiling, simulating and verifying the behavior of a presentation; and exporting the content.

15. The method of claim 14, wherein the exporting the content further comprises specifying one of the following: an image destination medium, an access control option, a commerce functionality, and a copy protection option.

16. The method of claim 14, wherein the exporting the content further comprises registering an author as a content provider.

17. The method of claim 14, wherein the exporting the content further comprises generating a registered output image.
